(19) United States
(12) Patent Application Publication
(10) Pub. No.: US 2021/0169271 A1
(43) Pub. Date: Jun. 10, 2021

(54) PROCESS AND TOOL FOR CLEANING BARBECUE GRILLS

(71) Applicants: Steven M. Vosberg, Parkland, FL (US); Timothy Haak, Parkland, FL (US)

(72) Inventors: Steven M. Vosberg, Parkland, FL (US); Timothy Haak, Parkland, FL (US)

(21) Appl. No.: 17/111,012

(22) Filed: Dec. 3, 2020

Related U.S. Application Data
(60) Provisional application No. 62/944,512, filed on Dec. 6, 2019.

(51) Int. Cl. A47J 37/07; B08B 1/00; A47L 13/34; A47J 43/28

(52) U.S. Cl. CPC A47J 37/0786; A47J 43/288; A47L 13/34; B08B 1/005

(57) ABSTRACT

A tool for cleaning barbecue grills includes a main body having an open mouth extending across a front face and along the opposite sides between upper and lower jaw members. The open mouth is specifically sized, structured and configured for tight fitted receipt of a stacked arrangement of corrugated cardboard strips so that a forward leading edge of the stacked arrangement of cardboard strips is positioned exteriorly and forward of the open mouth for movement against the barbecue grill surface in a manner that removes charred debris, grease and other undesirable substances, thereby cleaning the grill surface prior to cooking. The tool further includes a metal scraper blade, a bottle opener and an extended handle that removably attaches to the main body.

This non-provisional patent application is based on provisional patent application No. 62/944,512 filed on Dec. 6, 2019.

### BACKGROUND OF THE INVENTION

### Field of the Invention

The present invention relates to tools for cleaning barbeque grills and, more particularly, a device that is structured to hold one or more corrugated cardboard strips so that a forward leading edge of the one or more cardboard strips is positioned forwardly of the jaw for movement against a grill surface in order to remove grease, food particles and other cooking debris from the grill surface.

### Discussion of the Related Art

Cooking food on grills has become increasingly popular, both for outdoor and indoor cooking. In particular, outdoor grills are typically heated with use of either charcoal or a flammable gas such as propane. The process of cooking on grills, and particularly outdoor grills, results in the accumulation of grease, food particles and other charred debris on the grate surface of the grill. This charred debris is formed from the foods being cooked on the grate surface, such as meat, fish, vegetables, sauces, marinades and other food items. After use, or prior to cooking fresh food on the grill, it is desirable to clean the grill in order to remove the charred debris, grease and other undesirable substances from the grate surface which would otherwise impact the taste and appearance of the fresh food being cooked. Currently, the most common tools used for cleaning the grate surface of grills includes a wide variety of wire brushes, metal scrapers and wood plank scrapers.

Recently, it has been revealed that the use of wire brushes to clean the grate surface of barbecue grills is undesirable and potentially hazardous to a person's health due to the possibility of fragments of the wire brush being left on the grate surface which can attach to or become embedded in food that is cooked on the grill. This leads to instances where people unintentionally consume food that contains small wire fragments from the cleaning brush. In fact, x-rays of patients have revealed the presence of these small wire fragments in their stomach and other digestive tract tissue.

While metal scrapers are effective to remove clumps of charred debris that adhere to the grate surface of the cooking grill, they are generally not effective to remove all of the grease, grime, small charred particles and other debris. The same is true with wood plank scrapers which have become increasingly popular, particularly due to the public awareness of the dangers of wire brushes. Wood scrapers remove larger particles, but are not effective to fully clean the grate surface.

Considering the forgoing, there still remains a need for an effective grill cleaning tool that is safe to use, and which does not leave any harmful particles on the grill surface that might be subsequently ingested by people when eating food that has been cooked on the grill. Moreover, there is a need for a more effective barbecue grill cleaning tool that removes both larger pieces of charred debris that are stuck to the grill surface, as well as smaller particles and grease and grime that inevitably accumulates on the grate surface.

The present invention proposes a simple and highly effective process and tool for cleaning barbecue grills, wherein a stacked arrangement of corrugated cardboard strips is held in a manner that allows for use of a leading edge of the stacked arrangement of cardboard strips to be scraped along the grate surface of the grill to effectively remove charred particles, grease, grime and other undesirable residue from the grate surface prior to cooking on the grill. Unlike wire brushes, metal blade scrapers and wood plank scrapers, the stacked arrangement of cardboard effectively wipes the grate surface clean while leaving no harmful particles on the grate surface.

### SUMMARY OF THE INVENTION

It has been discovered by the Inventors of the present invention that the use of corrugated cardboard provides an excellent medium for cleaning the surface of barbecue grills which is more effective than use of metal scrapers, wire brushes and wood plank scrapers. More particularly, the Inventors of the process and tool of the present invention have discovered that at least one, and preferably two or more pieces of cardboard in a stacked arrangement, can be held in one hand so that the reinforced edge (i.e., the edge that reveals the corrugated construction) of the cardboard can be moved against the grill surface and in a back and forth scrubbing action, to thereby remove charred debris, grease, and other undesirable substances from the grill surface. Ideally, the grill surface should be heated to a temperature of at least 150-200 degrees Fahrenheit prior to cleaning.

A process for cleaning barbecue grills according to the present invention uses at least one, and preferably two or more pieces of cardboard held in a stacked arrangement. Preferably, the cardboard pieces are cut to the size of approximately 5-6 inches in length (i.e., measured between opposite ends) and 4-5 inches in width (i.e., measured between a front leading edge and a back edge). The process includes the steps of: heating the grill to a temperature of at least 150-200 degrees Fahrenheit; holding the cardboard pieces in one hand with the four fingers on the top of the cardboard stack and the thumb on the bottom of the stack so that the leading edges of the cardboard pieces have the corrugated (i.e., wave or serpentine core) construction revealed; and moving the leading edges of the stacked arrangement of cardboard pieces against the grill surface in a back and forth scrubbing action to remove debris, grease and other undesirable substances. The leading edges and front corners can also be moved along the edges of the grates and at least partially under the grates to remove charred debris and other substances therefrom. A tool for cleaning barbecue grills includes a main body having an upper jaw member, a lower jaw member, a back end extending between the upper and lower jaw members, opposite sides and a front face. The body is formed to include an open mouth between the upper and lower jaw members, with the open mouth extending across the front face and along the opposite sides. The open mouth is specifically sized, structured and configured for tight fitted receipt of a stacked arrangement of corrugated cardboard strips so that a forward leading edge of the stacked arrangement of cardboard strips is positioned exteriorly and forward of the open mouth for movement against the barbecue grill surface in a manner that removes charred debris, grease and other undesirable substances, thereby cleaning the grill surface prior to cooking. The interior of the open mouth may be provided with one or more teeth that are tapered in a manner that promotes sliding insertion of the stacked arrangement of corrugated strips within the mouth, while discouraging removal, as the teeth bite into the top and bottom surfaces of the stack of cardboard strips. The main body may further include a metal scraper extending forwardly, beyond the front face and a bottle opener on one side. The main body may further be structured for removable attachment of an extension pole or handle.

### BRIEF DESCRIPTION OF THE DRAWINGS

For a fuller understanding of the nature of the present invention, reference should be made to the following detailed description taken in conjunction with the accompanying drawings in which:

FIG. 1 is an exploded front, top perspective view of the barbecue grill cleaning tool of the present invention shown with an optional extension handle removed from the main body of the tool;

FIG. 2 is an exploded rear, top perspective view of the barbecue grill cleaning tool of the present invention shown with the extension handle removed from the main body of the tool;

FIG. 3 is a bottom plan view of the barbecue grill cleaning tool of the present invention;

FIG. 4 is a top plan view thereof;

FIG. 5 is a side elevational view of the barbecue grill cleaning tool shown with a strip of corrugated cardboard being inserted within an open mouth of the main body of the tool as teeth within the mouth engage the top and bottom surfaces of the strip of corrugated cardboard;

FIG. 6 is a side elevational view of the barbecue grill cleaning tool shown with the corrugated cardboard strip fully inserted within the open mouth of the tool with the teeth engaged and biting into the corrugated cardboard strip;

FIG. 7 is a perspective view showing the barbecue grill cleaning tool used with the corrugated cardboard strip for removing grease and other residue from the top surface of a barbecue grill;

FIG. 8 is a perspective view showing the barbecue grill cleaning tool of the present invention with the extension handle attached and the tool holding the corrugated cardboard strip for use in removing grease and other residue from the top surface of the barbecue grill;

FIG. 9 is a perspective view showing a rigid scraper blade on the main body of the barbecue grill cleaning tool being used for scraping and removing residue and other debris from the top surface of the barbecue grill; and

FIG. 10 is a front perspective view showing the corrugated cardboard strip fully received and engaged within the open mouth of the barbecue grill cleaning tool and revealing the corrugated, serpentine-shaped core construction of the corrugated cardboard strip along a leading edge thereof.

Like reference numerals refer to like parts throughout the several views of the drawings.

### DETAILED DESCRIPTION OF THE PREFERRED EMBODIMENT

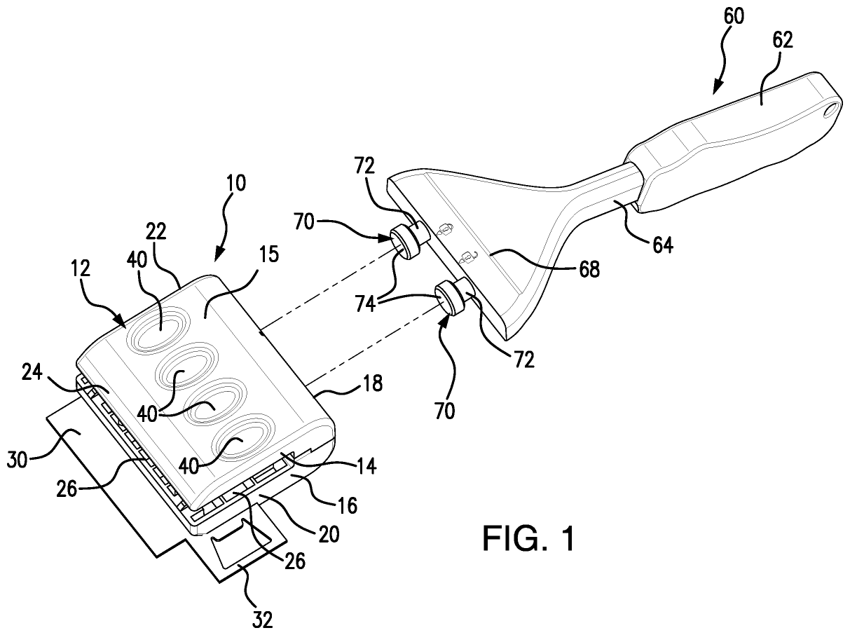

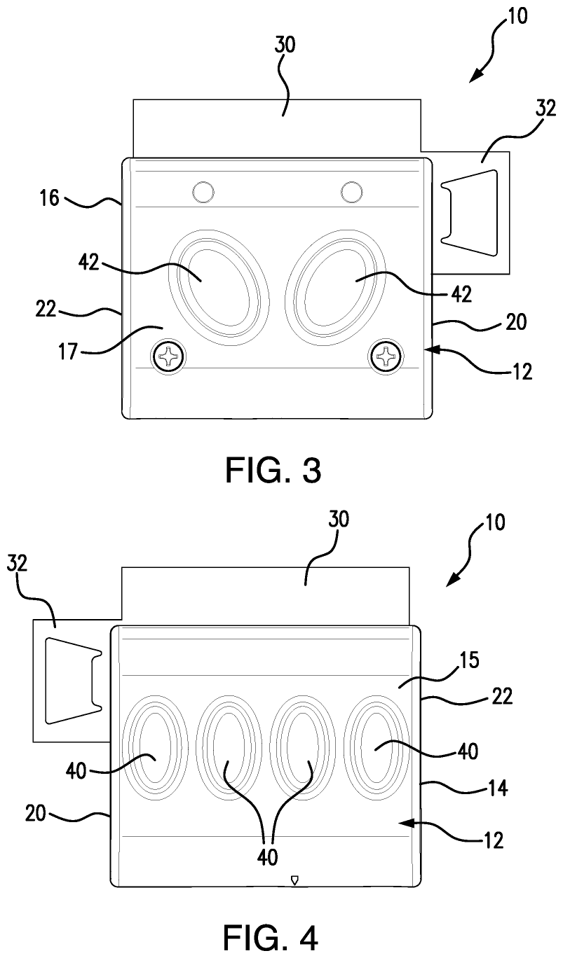

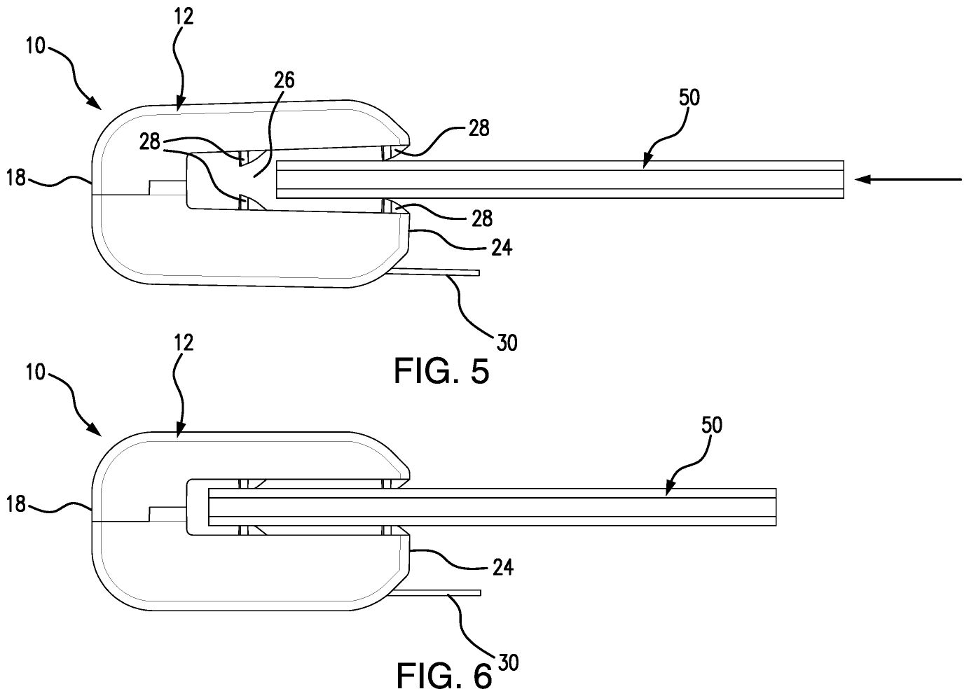

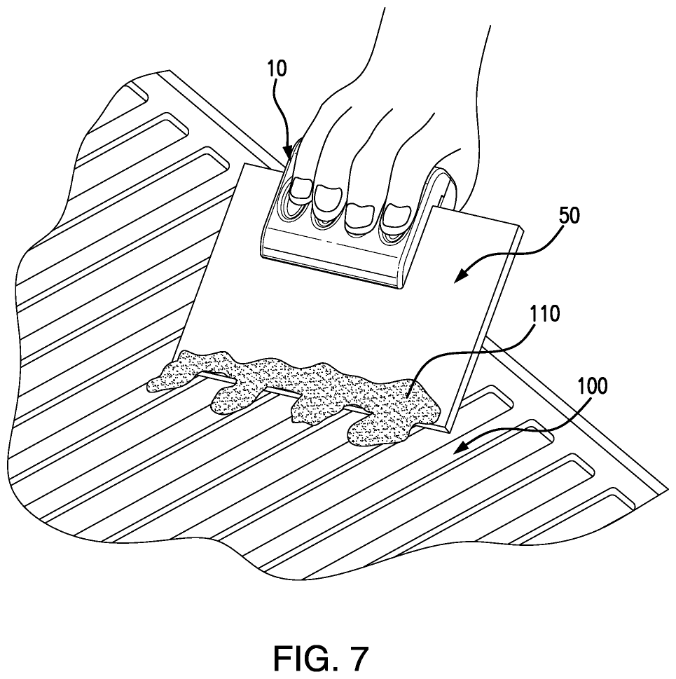

Referring to the several views of the drawings, and initially FIGS. 1-6, the barbecue grill cleaning tool of the present invention is shown and generally indicated as 10. The barbecue grill cleaning tool 10 of the present invention includes a main body 12 that may be formed as a single molded piece or, alternatively, as two or more pieces that are assembled together during manufacture. The main body 12 includes an upper jaw member 14 having a top surface 15 and a lower jaw member 16 having a bottom surface 17. The main body 12 further includes a back end 18 that is formed by the combined structures of the upper and lower jaw members. The back end 18 is preferably shaped and configured to provide for an ergonomic fit within a user's hand with the fingers on the top surface 15 and the thumb on the bottom surface 17. As seen in FIGS. 5 and 6, the back end 18 is rounded at the upper and lower corners to provide the desired ergonomic shape. The main body further includes a left side 20, a right side 22 and a front face 24. The front face 24 includes the front of the upper jaw member 14 and the front of the lower jaw member 16. An open mouth 26 extends across the front face 24 and partially along the opposite sides 20,22, between the upper jaw member 14 and the lower jaw member 16. Teeth 28 are provided within the open mouth 26 and are specifically shaped to allow insertion of one or several corrugated cardboard strips 50 into the open mouth, as indicated by the arrow in FIG. 5. The teeth 28 are rounded on the front facing side and have an abrupt, perpendicular edge on the back side so that the corrugated cardboard strip can slide into the mouth 26, while discouraging removal of the cardboard strip outwardly from the front face as the teeth 28 bite into the top and bottom surfaces of the corrugated cardboard strip. It should be noted that the drawing figures show a single corrugated cardboard strip 50 inserted within the open mouth 26 of the main body 12 of the tool 10. However, it is contemplated that a stacked arrangement of two or more cardboard strips 50 may be inserted into the open mouth.

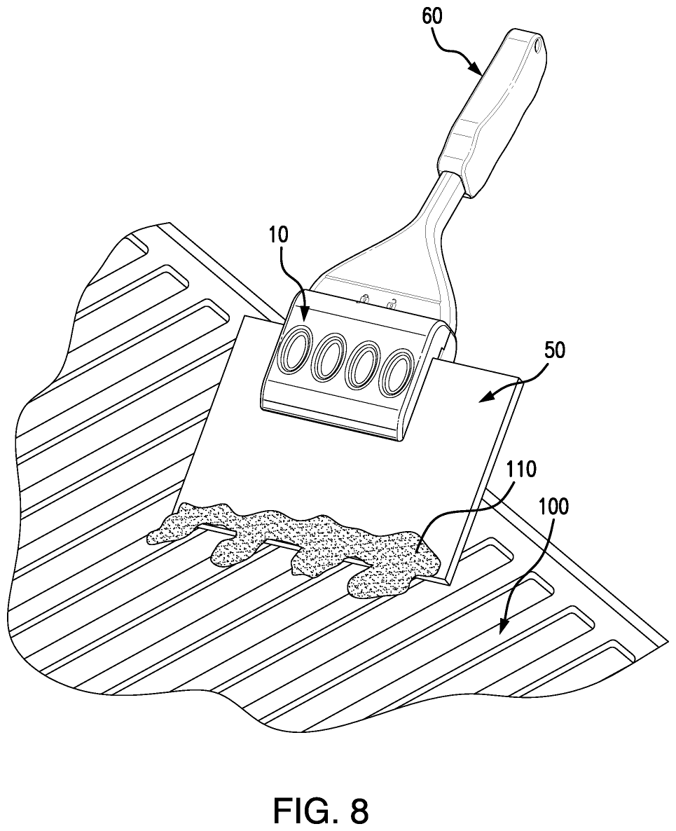

As seen in FIGS. 1-4, the main body 12 of the tool 10 further includes a rigid scraping blade 30 for use in removing charred debris and other food substances that are baked onto the barbecue grill surface. FIG. 9 illustrates use of the rigid scraping blade 30 to remove the grease, charred debris and other residue material 110 from the grill surface 100. The main body 12 further includes a bottle opener 32 that extends from one side of the main body. Preferably, the rigid scraping blade 30 and the bottle opener 32 extend from the lower jaw member 16. It is also noted that the rigid scraping blade 30 and the bottle opener 32 may be formed as one piece during manufacture and attached to the lower jaw member 16 by screw fasteners or other well-known means of fixed attachment. In at least one embodiment, the rigid scraping blade 30 and the bottle opener 32 are formed of a metal material such as stainless steel or aluminum. The rigid scraping blade 30 and the bottle opener 32 may also be provided with a protective coating that discourages rust and deterioration. Alternatively, the metal material of the rigid scraping blade 30 and the bottle opener 32 may be left bare, without any coating material. As seen throughout the several drawing figures, the main body is provided with concave depressions for receipt of the user's fingers and thumb. Specifically, the top surface 15 of the main body 12 includes four concave depressions 40 that are specifically arranged and positioned for placement of the tips of the user's four fingers therein, as seen in FIG. 7. The bottom surface 17 of the main body 12 includes two concave depressions 42 that are angled relative to one another for selective placement of either the right thumb or the left thumb of the user. More particularly, one of the concave depressions 42 is angled for receipt of the left thumb in the event the user prefers to grasp the tool 10 in the left hand, while the other depression 42 on the bottom surface 17 is angled to receive the right thumb in the event the user prefers to grasp the main body 12 of the tool 10 in the right hand. The finger depressions 40 and 42 on the top and bottom surfaces of the main body promote a better grip of the tool in the user's hand, while also providing for an ergonomic design that is more comfortable for the user.

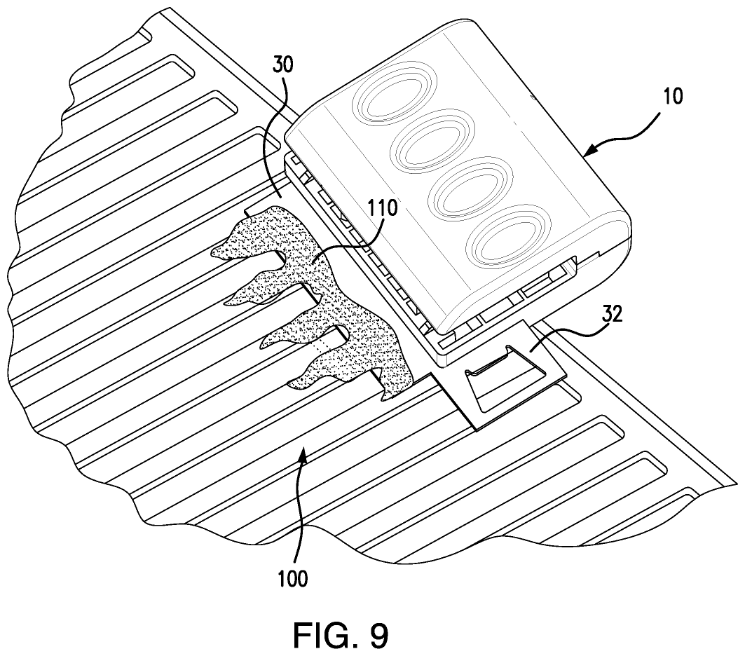

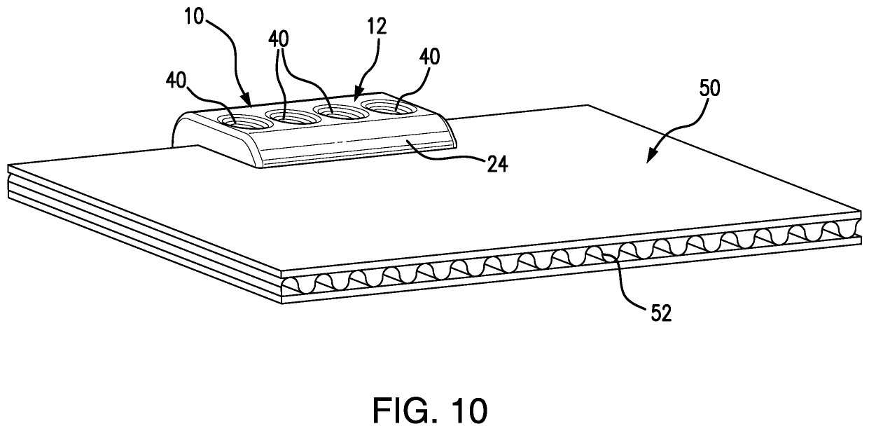

As seen in FIGS. 5-8 and 10, the open mouth 26 of the main body 12 is specifically sized, structured and arranged for tight fitted receipt of one or more corrugated cardboard strips 50 therein. As seen in the drawings, a corrugated cardboard strip 50 is comprised of a layer of cardboard having opposite side faces and an interior corrugated core 52 that has a serpentine or sinusoidal configuration. This corrugated configuration 52 is revealed at the leading edge of the corrugated cardboard strip 50 that engages the grill surface, as seen in FIGS. 7 and 8.

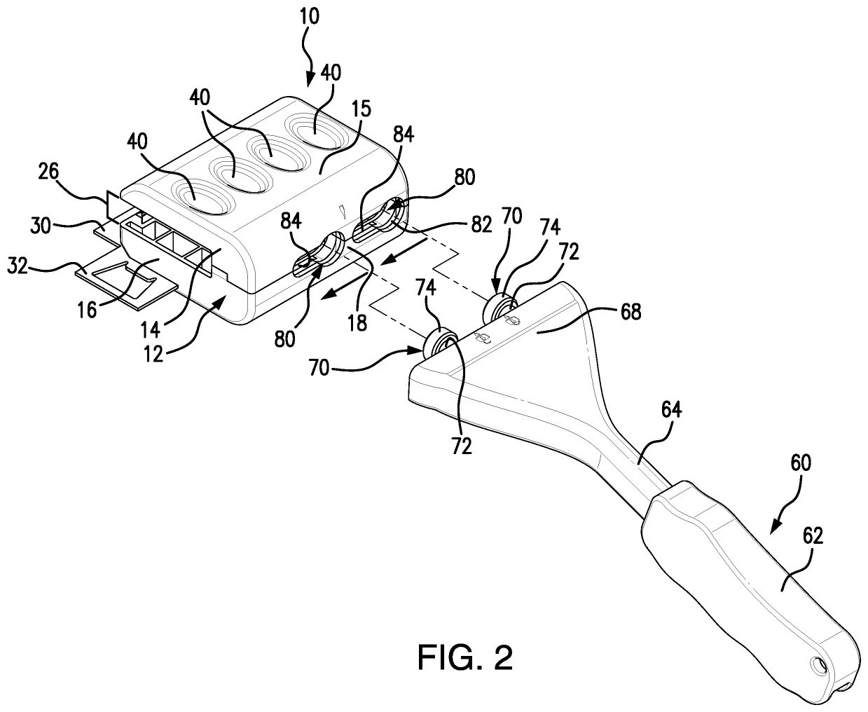

Referring to FIGS. 1-2 and 8, an optional handle extension 60 may be attached to the main body 12 to provide more leverage when scraping the grill surface 100, while also distances the user's hands from the grill surface 100 that may be hot. The handle extension 60 includes a handle grip 62 that is grasped in either the right hand or left hand of the user. A neck 64 extends from the handle grip 62 to a head 68 of the handle extension 60. The head 68 is specifically structured for removable attachment to the back end 18 of the main body 12 of the grill cleaning tool. More specifically, in one embodiment, the head 68 is provided with locking members 70 that are specifically structured for interlocking receipt within locking slots 80 in the back end 18 of the main body 12. In this particular embodiment, the locking members 70 each include a post 72 extending from a distal end of the head 68 and an enlarged head 74 on the end of the post 72. The enlarged head 74 of each of the locking members 70 is specifically sized and structured for receipt through a corresponding enlarged opening 82 of the locking slots 80 in the back end 18 of the main body 12. Once the enlarged heads 74 are fully inserted into the corresponding openings 82, the handle extension 60, and particularly the head 68, is moved sideways, as indicated by the arrows in FIG. 2, so that the posts 72 of the locking members 70 slide into slot extensions 84 of the locking slots 80 with the enlarged heads 74 of the locking members 70 captivated behind the slot extensions 84 and within the interior of the main body 12, thereby fixedly securing the handle extension 60 to the main body 12. The handle extension 60 can easily be removed by moving the head 68 in the opposite direction so that the enlarged heads 74 align with the enlarged openings 82 whereupon the locking members 70 can easily be removed from the locking slots 80.

Since many modifications, variations and changes in detail can be made to the described embodiments of the invention, it is intended that all matters in the foregoing description and shown in the accompanying drawings be interpreted as illustrative and not in a limiting sense. Thus, the scope of the invention should be determined by the appended claims and their legal equivalents.

What is claimed is:

1. A tool for cleaning barbecue grills comprising:
a main body having an upper jaw member with a top surface and a lower jaw member with a bottom surface, and the main body further including a back end, a left side, a right side and a front face, and an open mouth extending across the front face and at least partially open on the right and left sides of the main body; and
the open mouth being sized, structured and configured for receipt of at least one panel piece of corrugated cardboard therein, so that a front leading edge of the corrugated cardboard panel piece is positioned forwardly and exterior of the open mouth, wherein the leading edge of the corrugated cardboard panel piece is moved against a surface of the barbecue grill while grasping the main body of the tool to thereby remove grease, charred debris and other residue from the surface of the barbecue grill.

2. The tool as recited in claim 1 wherein the open mouth includes at least one tooth member that is structured and disposed for promoting sliding insertion of the at least one panel piece of corrugated cardboard into the open mouth while discouraging outward removal of the at least one panel piece of corrugated cardboard from the open mouth once fully inserted therein.

3. The tool as recited in claim 1 further including a rigid scraping blade extending outwardly from the front face of the main body and below the open mouth, and the rigid scraping blade including a linear edge for engaging the barbecue grill surface.

4. The tool as recited in claim 3 further including a bottle opener extending from the main body for removing a bottle cap from a beverage bottle.

5. The tool as recited in claim 1 wherein the main body includes a spaced arrangement of depressions on the top surface for receiving the digit fingers of a user's hand to thereby promote grasping of the main body within one hand of the user.

6. The tool as recited in claim 5 wherein the main body further includes a pair of concave depressions on the bottom surface, and the pair of concave depressions being angled relative to one another for receipt of either the left thumb or the right thumb of the user's hand while grasping the main body, thereby promoting a secure grasp of the main body within the user's hand.

7. The tool as recited in claim 1 further including a handle extension for removable attachment to the main body, and the handle extension including a handle portion and at least a head including attachment members thereon for removable attachment to the main body.

8. The tool as recited in claim 7 wherein the head of the handle extension and the back end of the main body are cooperatively structured for removable attachment of the head of the handle extension to the main body.

9. The tool as recited in claim 1 wherein the open mouth is sized, structured and configured for receipt of a plurality of panel pieces of corrugated cardboard in a stacked arrangement.
